(19) United States
(12) Patent Application Publication
(10) Pub. No.: US 2019/0139413 A1
(43) Pub. Date: May 9, 2019

(54) ANTI-COLLISION WARNING SYSTEM

(71) Applicant: John R. Austin, Bradbury, CA (US)

(72) Inventor: John R. Austin, Bradbury, CA (US)

(21) Appl. No.: 16/042,914

(22) Filed: Jul. 23, 2018

Related U.S. Application Data
(60) Provisional application No. 62/536,096, filed on Jul. 24, 2017.

(51) Int. Cl. G08G 1/16; G08G 1/07

(52) U.S. Cl. CPC G08G 1/166; G08G 1/07

(57) ABSTRACT

An anti-collision warning system for intersections includes a vehicle sensor adapted to detect an approaching vehicle; two or more warning strips, which contain signal-activated warning lights and function as gentle, but effective, speed bumps to approaching vehicles; and a controller coupled to the sensor and to the warning strips. The system is internally and/or externally powered and can be installed in a warehouse, factory, or other venue having an intersection where a vehicle path meets a pedestrian path, or where two vehicle paths meet. An improved warning strip/speed bump, adapted for use in the anti-collision warning system, includes an elongate member, preferably trapezoidal in cross-section, with an elevated upper face or top, opposed first and second ramp faces that converge toward the upper face, and a bottom face; a pair of longitudinal channel in the bottom of the member; and a plurality of LEDs secured within the channels.

### CROSS REFERENCE TO RELATED APPLICATIONS

This application claims the benefit of U.S. provisional patent application No. 62/536,096, filed Jul. 24, 2017, the entire contents of which are incorporated herein by this reference.

### FIELD OF THE INVENTION

The invention relates to systems for preventing vehicle-vehicle and vehicle-pedestrian collisions at intersections, particularly intersections found in warehouses, factories, and other industrial settings.

### BACKGROUND OF THE INVENTION

Industrial workplaces are often crowded, noisy, and bustling with activity, with dangerous blind intersections where the paths of rolling stock and pedestrians meet. Workers face numerous auditory and visual challenges. High racks of shelves, pallets, and equipment make it difficult to see around corners. The noise in some facilities is sufficiently high that workers are required to wear earplugs, making it difficult to hear approaching vehicles. Compounding the problem, electric-powered and propane-powered forklifts and utility vehicles tend to be relatively quiet. Consequently, when a worker approaches a blind intersection where rolling stock may be encountered, there is a serious risk of a collision between vehicle and pedestrian. Vehicle-vehicle collisions are also a serious problem.

Numerous efforts have been made to prevent vehicle-vehicle and vehicle-pedestrian collisions at intersections in industrial settings. The simplest approach is to provide a visual warning, such as a striped or solid yellow line of paint, at the threshold of the intersection. A passive visual cue, however, is at most marginally effective, as it tends to be very easily missed or even ignored by drivers and pedestrians. Another approach that has been used is to place one or more convex mirrors at the corners of the intersection. Such mirrors, however, tend to distort distances and are not always visible, particularly to an approaching vehicle that is laden down with boxes, pallets, or other large objects. In addition, mirrors tend to be mounted at a high location and may not be seen if an approaching pedestrian is looking down as he or she approaches the intersection. At the opposite end of the spectrum, very complex—and expensive—systems have been devised in which every worker at the facility carries on his or her person a sensor and/or detector, and every vehicle on site carries a sensor and/or detector, so that, whenever two vehicles (or a pedestrian and a vehicle) approach, there is mutual detection, electronic communication, and auditory and/or visual warning.

Means for actively detecting vehicles and pedestrians and providing a visual or auditory warning when a vehicle approaches have been described in the art. For example, U.S. Pat. No. 4,928,101 (Favors) describes an ultrasonic anti-collision detector and warning system that is mounted at the corner of a blind intersection. When two objects—vehicles, pedestrians, a vehicle and a pedestrian—approach the sensor from different directions, a warning signal is activated. A potential drawback to this system is over activation, particularly in facilities where there are many more pedestrians than vehicles. If an alarm is activated every time two workers approach each other from opposite sides of a blind intersection, the overall effectiveness of the system is likely to be degraded, as workers become complacent and “tune out” the warnings.

Current anti-collision systems tend to rely solely on auditory and/or visual cues to get the attention of approaching vehicles and pedestrians. Unfortunately, a painted warning stripe, mirror, or even a flashing light or alarm will not, by itself, stop or even slow a forklift, just as a red light at a street corner does not stop every car from passing through an intersection. What is needed is an intersection warning system which, in addition to providing a visible cue to approaching vehicles and pedestrians alike, physically encourages approaching vehicles to slow down before they enter the intersection.

### SUMMARY OF THE INVENTION

In a first aspect of the invention, an anti-collision warning system includes a sensor adapted to detect an approaching vehicle; two or more warning strip speed bumps (“warning strips”), which contain signal-activated warning lights and function as low profile speed bumps to approaching vehicles; and a controller. The controller is coupled, directly or indirectly, to the sensor and to the warning strips. In one embodiment, a flasher circuit is embedded in the controller, or provided as a discrete flasher unit or module coupled between the controller and the warning strips. The controller, or controller/flasher, regulates the duration and/or sequence of light flashes emitted by the LEDs in the warning strips.

The anti-collision warning system is internally and/or externally powered and can be installed in a warehouse, factory, or other venue having an intersection where a vehicle path meets a pedestrian path, or where two vehicle paths meet. Thus, a first warning strip is secured to and across (i.e., transverse to) the first path, preferably at least slightly upstream of the intersection. A second warning strip is secured to and across (i.e., transverse to) the second path, preferably at least slightly upstream of the intersection from a different direction. The sensor is mounted in or near the intersection at a location that permits detection of an approaching vehicle well before the vehicle can enter the intersection. When a vehicle approaches the intersection, it is detected by the sensor, which emits a signal that is perceived by the controller. The controller (or controller/flasher) sends a signal that activates light-emitting diodes (LEDs) in the warning strips, and causes them to flash for a predetermined period of time, or until the vehicle crosses the intersection and begins moving away from it. The flashing lights in the first warning strip alert the vehicle approaching the intersection along the first path, while lights in the second warning strip alert any pedestrian or vehicle approaching the intersection along the second path. In addition, because the warning strips have a slightly elevated profile, they function as gentle speed bumps to ensure that any approaching vehicle slows down before it enters the intersection.

In a second aspect of the invention, a kit is provided for equipping an intersection with an anti-collision warning system to prevent vehicle-vehicle and vehicle-pedestrian collisions, particularly at intersections found in industrial settings. In one embodiment, the kit includes a sensor, controller (or controller/flasher), and a single warning strip. In a second embodiment, the kit includes a sensor, controller (or controller/flasher), and two or more warning strips.

In a third aspect of the invention, an improved warning strip speed bump, adapted for use in the anti-collision warning system, comprises a low profile, elongate member having a plurality of LEDs housed therein. The elongate member has an elevated upper surface, which may be ramped or convex, and a width-to-height ratio of from about 15:1 to 64:1. In a preferred embodiment, the LEDs are housed beneath the upper surface of the elongate member and, when energized, emit light that passes through at least a portion of the elongate member and beyond its outer surface. In one embodiment, the elongate member is substantially trapezoidal in cross-section, with an elevated upper face or top, opposed first and second ramp faces that converge toward the upper face, and a bottom face, and the LEDS are spaced apart longitudinally along the length of the member in one or more rows. Advantageously, the LEDs can be provided as flexible light strips or ribbons located in narrow grooves or channels in the bottom or interior of the member.

### BRIEF DESCRIPTION OF THE DRAWINGS

Various features and advantages of the invention will be understood more completely when considered in conjunction with the accompanying drawings (which are not necessarily drawn to scale), wherein:

FIG. 1 is a perspective schematic view of an intersection equipped with an anti-collision warning system according to one embodiment of the invention;

FIG. 2 is a block diagram showing various components of the anti-collision warning system embodiment shown in FIG. 1;

FIG. 3 is a cross-sectional view of an improved warning strip speed bump (“warning strip”) according to one embodiment of the invention;

FIG. 4 is a close up view of one side of the warning strip shown in FIG. 3;

FIG. 5 is a cross-sectional view of a warning strip similar to FIG. 3, with LED light strips seated in channels in the warning strip; and

FIG. 6 is a bottom view of the warning strip shown in FIG. 5.

### DETAILED DESCRIPTION

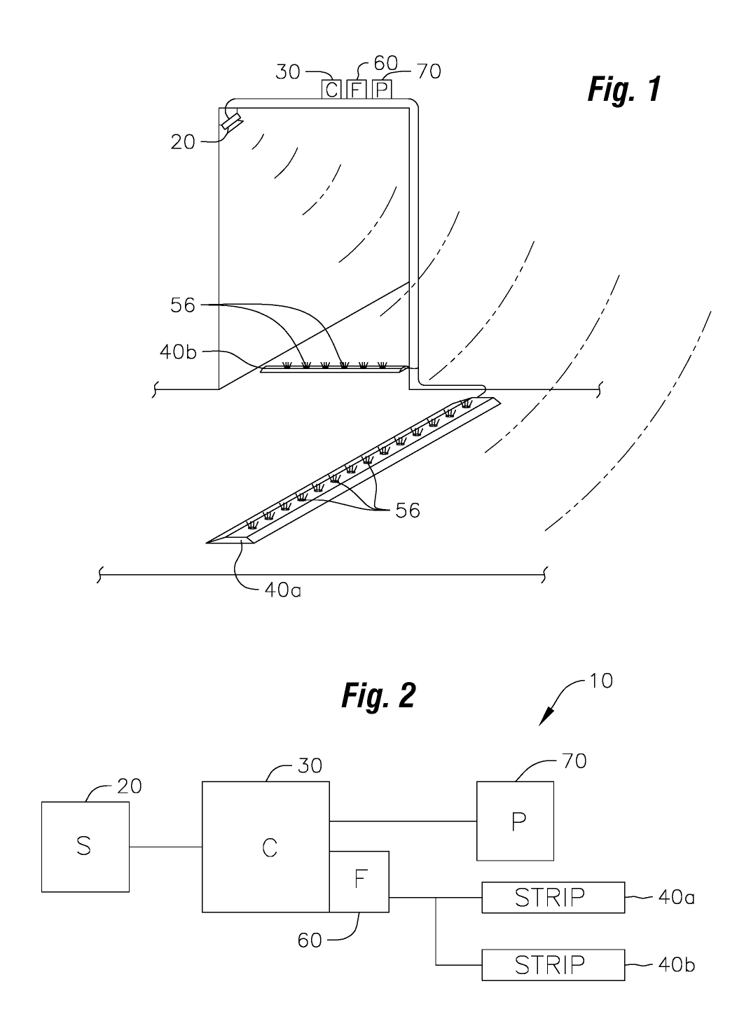

Referring now to FIG. 1, a “blind” intersection where two paths meet in a warehouse is schematically depicted. The intersection is equipped with an anti-collision warning system according to one embodiment of the invention. The system 10 includes a sensor 20, which is configured and positioned to detect an approaching forklift or other vehicle before the vehicle enters the intersection; a controller (control module) 30, which monitors sensor output and routes power to various components of the system; and a pair of warning strips 40a, 40b. The warning strips house a plurality of light-emitting diodes 56. A flasher circuit or solid state component is either embedded within the controller or coupled thereto as a separate module (flasher module) 60 and is also coupled to the warning strips. Power is provided by a 24 VDC switching power supply 70, which plugs into a 120 VAC outlet (not shown). A remote control (not shown) is provided to adjust sensor settings from the floor during initial set up, or as needed.

A block diagram showing the components of the anti-collision warning system 10 is provided in FIG. 2. The sensor 20 can detect an object as it approaches the intersection. The object may be a vehicle, such as a forklift, utility vehicle, tugger, AGV, maintenance cart, etc., or a person, i.e., pedestrian. Preferably, the sensor is capable of distinguishing between vehicles and pedestrians, and between objects that are approaching the sensor and objects that are moving away from the sensor. Nonlimiting examples of sensors include microwave sensors, passive infrared (IR) sensors, radio frequency identification (RFID) sensors, laser sensors, magnetic sensors, ultrasonic sensors, photo sensors, calibrated radar sensors, and combinations of such sensors, for example, a microwave sensor combined with a passive IR motion detector. In a preferred embodiment, the sensor is a microwave sensor having an adjustable range of up to 60′ and an approximate field width of 12′ at 50′. It can be configured using an IR remote control that is bidirectional and allows programmed settings to be read out and changed from the floor. One example is the Hercules 2 microwave sensor (part no. 223152) from Bircher Reglomat (Beringen, Switzerland; http://reglomat.bircher.com).

The sensor can be mounted on the ceiling, on a wall or shelving rack, or on any other surface that permits an unhindered view of the area to be monitored for approaching traffic. In one embodiment, the sensor range is set so that there is an advance warning, e.g., 2 to 4 seconds, before an approaching vehicle will pass the threshold of the intersection. In addition, in one embodiment, the sensor will time out and reset after a selected period of time to permit vehicles to exit the area of the intersection (or the sensor's field of view), for example, 4 to 6 seconds. Multiple sensors can be used to detect traffic approaching the intersection from different sides, e.g., from opposite directions, from two or more orthogonal pathways, or from any other pathways leading to the intersection.

The controller 30 is a CPU-based module that monitors sensor output and switches power to the warning strips, directly or indirectly, via a relay or solid state device. In one embodiment, the control module is a microcontroller (having a CPU, a fixed amount of RAM, ROM, and other peripherals embedded on a single chip), with I/O terminals, printed circuit board (pcb) headers, and other connectors to couple the controller to other components of the warning system 10. The controller may use selectable inputs (e.g., dipswitches), and may also have a low voltage (e.g., 5 VDC) internal power supply, indicator LEDs, etc. One example of such a controller is the DWA-MW2 from Alert Safety Products (Cincinnati, Ohio; http://alertsafetyproducts.com/). In some embodiments, the controller receives input from a plurality of sensors, each placed to monitor vehicle traffic from a given direction or directions, and switches power to several (i.e., more than 2) warning strips as the situation requires.

The flasher 60 controls the flash rate of the LEDs in the warning strips. It can be integrated on the controller pcb to simplify installation, or provided as a stand-alone module. In one embodiment, the flasher contains a microprocessor or microcontroller, internal power supply (e.g., 5 VDC), a power MOSFET or other semiconductor device, and 3-position terminal. When the flasher 60 receives a signal from the controller 30, it provides power (24 VDC) to the LEDs on the warning strips, at a selected switch rate (e.g., 0.9 Hz). One example of a suitable flasher is the FLS-2a flasher module from Alert Safety Products.

The switching power supply 70 converts AC voltage to DC voltage. A nonlimiting example of such a power supply is a 70 watt 24 VDC switching power supply unit (MDS072T-P240) from Mega Electronics, Inc. (New Brunswick, N.J.; www.megaelectronics.com. The power supply has a power cord that plugs into a 120 VAC outlet, and a two-conductor cable, which is connected to the controller 30.

In both FIGS. 1 and 2, the controller, flasher, and power supply are depicted as discrete units. However, in some embodiments two or more of the components are housed together and form a unitary module. Whether provided separately or jointly, the components can be linked, directly, or indirectly, by suitable electrical connectors (e.g., wires, cables, printed circuit boards, etc.). The sensor is linked to the controller by a wire, cable, or wireless network connection.

Referring again to FIG. 1, two warning strips 40a, 40b are placed across two orthogonal paths that lead to the intersection. Each warning strip is placed slightly “upstream” of the intersection, along a given path. Thus, the first warning strip 40a is placed across (i.e., transverse to) path A, outside the intersection, and the second warning strip 40b is placed across (i.e., transverse to) path B, outside the intersection. The warning strips may be placed at the threshold of the intersection or, more preferably, 1-4 feet upstream of the intersection. Mounting the warning strips slightly upstream of the intersection can help reduce the risk of collisions between objects (e.g., vehicle-vehicle and vehicle-pedestrian), as additional time will pass from the moment one vehicle first encounters the warning strip until it actually enters the intersection, where another object (vehicle or pedestrian) may have already entered the intersection from around the blind corner.

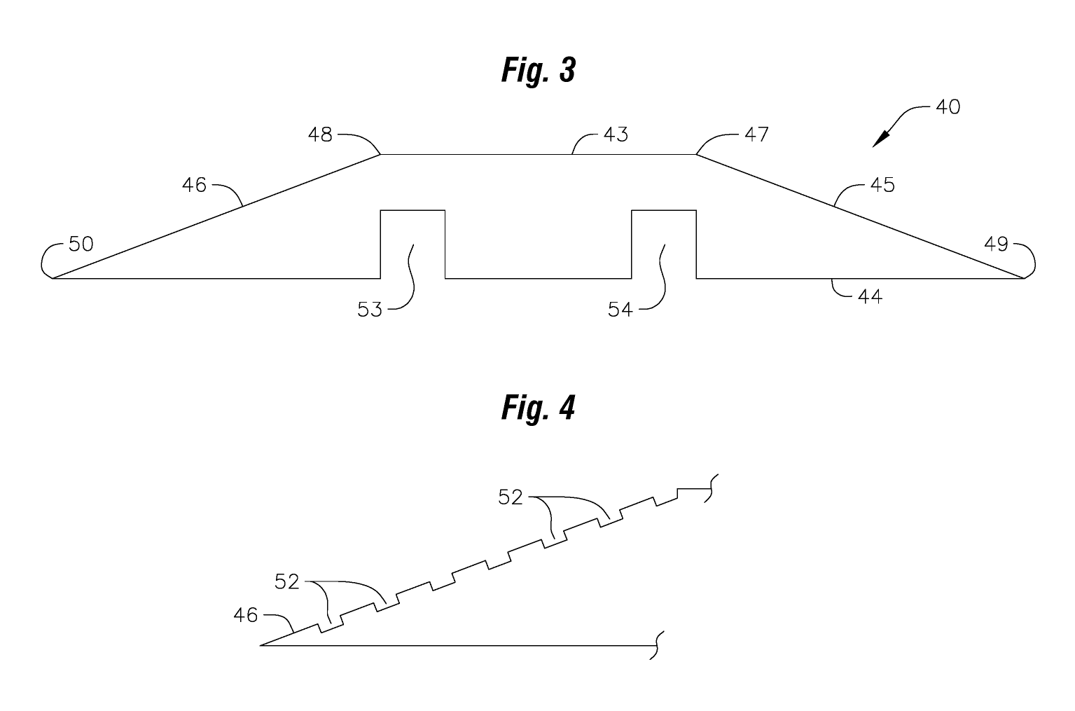

One embodiment of a warning strip according to the invention is shown in FIGS. 3-6. The warning strip 40 is a low profile, elongate member with left and right ends 41, 42 and is substantially trapezoidal in cross section. Thus, the warning strip has a flat upper face or “top” 43 and a flat lower face or “bottom” 44. Front and rear ramp faces 45, 46 slope upwardly from the lower face 44 toward the upper face 43 of the warning strip at a slight angle, e.g., 8-15°, more preferably 8-10°. The front ramp face 45 meets the top of the warning strip at a first (front) inner edge 47, and the rear ramp face 46 meets the top of the warning strip at a second (rear) inner edge 48, opposite the first (front) inner edge 47. Similarly, the front and rear ramp faces 45, 46 meet the bottom 44 of the strip at opposite front and rear outer edges 49, 50. Due to the acuteness of the angles between the front and rear faces and the lower face, the front and rear outer edges 49, 50 of the strip are very nearly “knife” edges, with a thickness of 0.1 inches or less. Alternatively, the tips of the knife edges can be slightly more truncated to strengthen this part of the warning strip.

The upper surface of the warning strip can be textured, in whole or in part, to increase its coefficient of friction and thereby enhance the strip's ability to slow down a vehicle as the vehicle encounters the warning strip. One embodiment of a textured upper surface is shown in FIG. 4. A number of very shallow (e.g., 1/32 to 1/16 of an inch) grooves 52 are formed in either or both of the front and rear ramp faces 45, 46 of the warning strip, preferably across the entire length of the strip. In another embodiment (not shown), the surface texture has some other morphology, which may be patterned or random. Nonlimiting examples include knurled, swirled, pebbled, and sand-like textures. Alternatively, if the warning strip will be used in an environment where large amounts of dust, dirt, grit, oil, or other debris are present, the upper surface can be made smooth, with minimal surface depressions, to reduce the collection of debris on the surface of the warning strip.

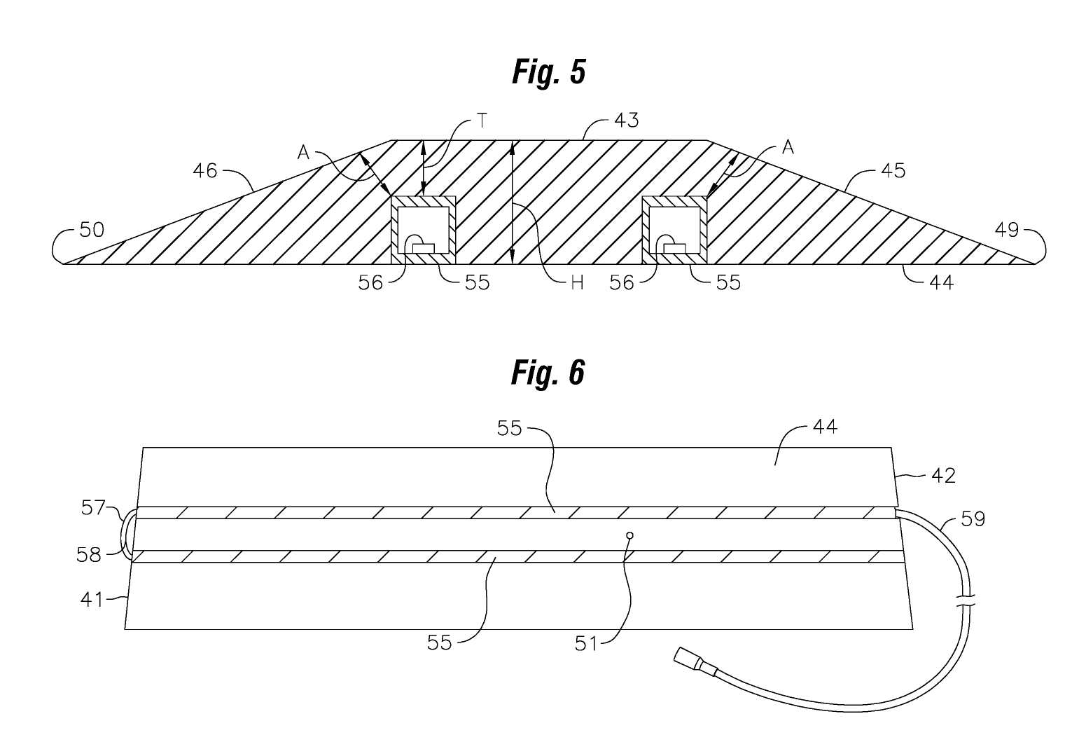

Referring now to FIGS. 3 and 5, two longitudinal channels 53, 54 are formed in the bottom 44 of the warning strip and extend from the left end 41 to the right end 42 thereof. Each channel houses a LED light strip or “ribbon” 55 having a plurality of LEDs 56. LED light strips are well known and generally consist of a flexible printed circuit board (pcb) with surface-mounted LEDs, resistors, contacts, and sometimes other components. The LEDs are typically spaced apart from each other by a set distance, e.g., one inch. Preferably, the pcb and its components are sealed in a protective, waterproof matrix, such as a heat-conductive epoxy or silicone. Some light strips come with an adhesive backing to secure the strips in place. In FIG. 5, the light strips 56 are held in their respective channels 53, 54 by a simple press fit (friction fit), with the width of each channel being just large enough to accommodate a light strip.

Housing the LEDs in one or more channels formed in the body of the warning strip protects the LEDs from compressive forces, such as the weight of a forklift passing overhead. As shown in FIG. 5, the warning strip has an overall thickness or height (“H”), and an internal thickness (“T”) between the top of each channel and the upper, outer surface of the warning strip. The diagonal distance between the front (or rear) ramp and the closest, upper corner of a given channel is denoted by the letter “A.” For a material of given compressive strength, the parameters H, T, and A can be selected to ensure that the warning strip will withstand compressive forces without substantial deformation and, as a result, protect the LEDs from damage when vehicles pass over the strip.

When the LEDs are activated, they emit a very bright light. However, in the embodiment of the invention shown in FIGS. 3 and 5, in order for that light to be seen by an observer the warning strip must be transparent or translucent, as the LEDs are seated in channels beneath the upper surface of the warning strip. Fortunately, high-density polyethylene (HDPE) is both translucent and strong, with a compressive strength on the order of 4600 psi (31.7 MPa). In addition, it can be extrusion molded in long segments, making it a preferred material for constructing warning strips of the type herein described. A pigment can be added before extrusion (using, e.g., the color masterbatch method) to impart color to the strip. A preferred color is “safety yellow,” a high-visibility safety color defined by ANSI standard Z535.

Alternatively, the warning strip can be made of some other material, so long as it has a high compressive strength and is transparent or translucent. Or, an opaque material can be employed, but the light strips (or individual LEDs) will then need to be recessed in protective channels (or holes) accessible from the upper surface of the warning strip so that light emitted from the LEDs is visible to observers.

Referring now to FIG. 6, the LED light strips are electrically coupled to each other by a pair of insulated connecting wires 57, 58 which are soldered to one end of each light strip. Similarly, a coaxial cable or other electrical lead 59 is soldered to an opposite end of one of the light strips to provide means for electrically coupling the warning strip to the controller/flasher/power supply of the system. The connecting wires 57, 58 project slightly beyond the left end 41 of the warning strip. In an alternative embodiment, the connecting wires are seated in a shallow, transverse channel (not shown) linking the longitudinal first and second channels in the bottom of the warning strip.

Each warning strip has a low profile yet is sufficiently thick (high) to act as a speed bump for forklifts and other vehicles. In this context, the term “low profile” means that the warning strip has a height of about ⅛ to 2 inches; preferably ⅛ to 1 inch; more preferably ⅛ to ½ inch. The width and height of the strip are selected so that the strip can perform its function—inducing the driver of an approaching vehicle to slow down before entering the intersection—without jeopardizing the driver's safety or unsettling the load carried by the vehicle. If the warning strip is too wide and/or too low, a driver may grow complacent and have less incentive to slow down before crossing over it. If the strip is too narrow and/or too high, there is a risk that the vehicle's load will be dislodged as the vehicle crosses the warning strip. While not being limited to a particular width and height, in one embodiment of the invention the warning strip has a width of from about 4″ to 8″ and a height of about ⅛″ to 1″, measured from top to bottom at the middle of the cross section. More preferably, the strip has a width-to-height (W:H) ratio of from about 15:1 to 32:1. Table 1 presents several nonlimiting options:

TABLE 1
Sample Width, Height and W:H Ratios

| Width | Height | W:H | Width | Height | W:H | Width | Height | W:H |
|---|---|---|---|---|---|---|---|---|
| (W) | (H) | Ratio | (W) | (H) | Ratio | (W) | (H) | Ratio |
| 4″ | 0.125″ | 32:1 | 6″ | 0.125″ | 48:1 | 8″ | 0.125″ | 64:1 |
| 4″ | 0.25″ | 16:1 | 6″ | 0.25″ | 24:1 | 8″ | 0.25″ | 32:1 |
| 4″ | 0.5″ | 8:1 | 6″ | 0.5″ | 12:1 | 8″ | 0.5″ | 16:1 |
| 4″ | 1.0″ | 4:1 | 6″ | 1.0″ | 6:1 | 8″ | 1.0″ | 8:1 |

In general, each warning strip is sized to fit the space where it will be installed. In a warehouse or similar facility, this may be several feet across, even 10′, 20′, or more. Two or more warning strips can be joined together, end to end, as needed to protect a wider intersection or other area. A plurality of mounting holes 51 extend through the warning strip and can accommodate a plurality of fasteners (not shown) to secure the warning strip to the floor (if the intersection or space to be protected is locate in the interior of a building) or to the ground or pavement (if the intersection or space is located in an outside facility).

The anti-collision warning system of the present invention can be employed in a number of ways, with the location and layout of various components conforming to the industrial setting or other venue. For example, in some warehouses, a main corridor is intersected by numerous side aisles. If forklifts and other vehicles primarily traverse only the main corridor, while pedestrians traverse both the main corridor and the side aisles, then the sensors 30 should be located to detect vehicles as the vehicles move about the main corridor and approach the individual side aisles. Warning strips should be placed near each intersection—from both the side aisle direction and the main corridor direction. In other venues, vehicles move throughout the entire facility, and sensors will need to be placed accordingly to detect the approach of vehicles from several directions at each intersection.

It will be apparent that 3-way (“T”) and 4-way intersections may require that 2-4 sensors and more than two warning strips are employed to ensure adequate coverage of the intersection. On the other hand, depending on the range and field of view of the sensor, in some embodiments of the invention a single sensor, strategically placed at the corner of an intersection, can be used to detect a vehicle as it approaches from either of two orthogonal directions.

Upon reading this disclosure, other embodiments and modifications will be apparent to the skilled person. For example, instead of being generally trapezoidal in cross section, the warning strip(s) can be generally triangular, with opposed first and second ramp faces that meet each other at the apex of the triangle. In another embodiment, the elongate member has an arcuate (convex) upper surface, rather than a ramped surface. As another alternative, instead of two longitudinal channels in each warning strip speed bump, a single channel, housing a plurality of LEDs, can be employed. The channel(s) need not be formed in the bottom of the warning strip speed bumps, but can be formed in the upper surface or top of the warning strip speed bumps, or wholly within the interior of the body of the warning strip speed bumps.

Even more generally, in another aspect of the invention, a light block comprises a member formed of HDPE, the member having an interior body, an outer surface, and a bottom surface, with a plurality of LEDs housed within the body at a depth shallow enough to permit light to pass through at least a portion of the member and exit from the outer surface when the LEDs are energized. Such a light block protects the LEDs against physical impacts and other potentially damaging exposures e.g., water, heat, dust, fumes, etc., and can be utilized wherever there is a need for protected illumination. In one embodiment, the member is an elongate member, which can have a low profile or, alternatively, a more prominent profile. A channel or multiple channels are formed in the member, with LEDs housed in the channel(s). For example, a light strip, with a line of LEDs, can be placed within the channel(s). The channels may extend from the bottom surface of the light block, well into the interior of the block, though advantageously stopping short of the (opposed) outer surface.

In these and other embodiments, instead of LED light strips, discrete LEDs can be wired together and housed within the warning strip speed bumps or light blocks. Instead of longitudinal channels, transverse channels can be used, or the LEDs can be housed in discrete holes formed in the warning strips or light blocks, with accommodation being made for electrical connections. All such variations, embodiments, and modifications fall within the scope of the present invention, which is limited only by the appended claims and equivalents thereof.

What is claimed is:

1. A anti-collision warning system, comprising:
a sensor adapted to detect an approaching vehicle;
two or more warning strip speed bumps, each housing a plurality of signal-activated warning lights; and
a controller coupled, directly or indirectly, to the sensor and to the warning strip speed bumps; wherein the controller is configured to send power to the warning strip speed bumps in response to a signal received from the sensor, thereby causing the warning lights to emit light.

2. The anti-collision warning system of claim 1, wherein the sensor comprises a microwave sensor.

3. The anti-collision warning system of claim 1, wherein the warning lights comprise light-emitting diodes (LEDs).

4. The anti-collision warning system of claim 3, wherein the LEDs populate one or more flexible light strip, each light strip being housed within at least one of the warning strip speed bumps.

5. The anti-collision warning system of claim 1, further comprising a flasher circuit or solid state device embedded in the controller or coupled between the controller and the warning strip speed bumps and adapted to cause the warning lights to flash for a controlled duration and frequency in response to a signal from the controller.

6. The anti-collision warning system of claim 1, wherein each warning strip speed bump comprises an elongate member having one or more longitudinal channels formed therein, and wherein the warning lights reside in the channel(s).

7. The anti-collision warning system of claim 6, wherein the elongate member has a first end and an opposite second end, and at least one of the longitudinal channels extends substantially from the first end to the second end.

8. The anti-collision warning system of claim 6, wherein each longitudinal channel is formed in the bottom of the elongate member.

9. The anti-collision warning system of claim 6, wherein the elongate member is substantially trapezoidal in cross section.

10. The anti-collision warning system of claim 6, wherein the elongate member has a width-to-height (W:H) ratio of about 15:1 to 32:1.

11. The anti-collision warning system of claim 6, wherein the warning lights comprise LEDs mounted on light strips, with at least one light strip per warning light speed bump.

12. A anti-collision warning system, comprising:
a sensor adapted to detect an approaching vehicle;
two or more warning strip speed bumps, each warning strip/speed bump comprising an elongate member having one or more longitudinal channels formed therein;
a light strip housed in each channel;
a controller coupled to the sensor;
a flasher coupled to the controller and to the warning strips; wherein the controller is configured to send power to the flasher module in response to a signal received from the sensor, and the flasher is adapted to respond to a signal from the controller by providing power to the warning strip speed bumps at a selected switch rate, thereby causing the light strips to emit flashing light.

13. The anti-collision warning system of claim 12, wherein the sensor comprises a microwave sensor.

14. The anti-collision warning system of claim 12, wherein the elongate member is substantially trapezoidal in cross section.

15. The anti-collision warning system of claim 12, wherein the elongate member has a first end and an opposite second end, and at least one of the one or more longitudinal channels extends substantially from the first end to the second end.

16. A warning strip speed bump, comprising:
an elongate member having a left and right ends, an upper surface, a bottom, a front lower edge, and a rear lower edge;
one or more channels formed in the bottom of the elongate member; and
a plurality of LEDs housed in the channel(s).

17. The warning strip speed bump of claim 16, wherein the elongate member is formed of a translucent material, and wherein, when the LEDs are energized, they emit light that passes through the elongate member and is visible beyond the upper surface of the member.

18. The warning strip speed bump of claim 17, wherein the translucent material comprises high density polyethylene (HDPE).

19. The warning strip speed bump of claim 18, wherein the HDPE is pigmented.

20. The warning strip speed bump of claim 16, wherein the LEDs populate one or more flexible light strips housed within the channel(s).

21. The warning strip speed bump of claim 16, wherein the elongate member has a width-to-height (W:H) ratio of about 15:1 to 32:1.

22. The warning strip speed bump of claim 16, wherein the elongate member is substantially trapezoidal in cross section, with a ramp angle of about 8 to 15°.

23. The warning strip speed bump of claim 16, wherein the ramp angle is about 8 to 10°.

24. A kit for improving safety at an intersection traversed by vehicle, pedestrians, or both vehicles and pedestrians, comprising:
a sensor adapted to detect an approaching vehicle;
one or more warning strip speed bumps, each housing a plurality of signal-activated warning lights; and
a controller coupled, directly or indirectly, to the sensor and to the warning strip speed bump(s); wherein the controller is configured to send power to the warning strip speed bump(s) in response to a signal received from the sensor, thereby causing the warning lights to emit light.

25. A light-emitting substrate, comprising:
an elongate member having an outer surface, formed of translucent HDPE; and
at least one LED housed within the member below the outer surface at a depth shallow enough to permit light to pass through the HDPE and exit from the outer surface when the LED is energized.

26. A light block, comprising:
a member formed of HDPE, having an interior body, an outer surface, and a bottom surface; and
a plurality of LEDs housed within the body at a depth shallow enough to permit light to pass through the body and exit from the outer surface when the LEDs are energized.

27. The light block of claim 26, wherein the member is an elongate member.

28. The light block of claim 27, wherein the elongate member has a low profile.

29. The light block of claim 26, wherein LEDs are housed in one or more channels formed in the elongate member.

30. The light block of claim 26, wherein the channel(s) extend from the bottom surface into the body of the member.
